(19) United States
(12) Patent Application Publication
(10) Pub. No.: US 2026/0332437 A1
(43) Pub. Date: Oct. 22, 2026

(54) Secure Attribution System for Human Influence in Generative Artificial Intelligence

(71) Applicant: Brian Andrew Digate, Madison, WI (US)

(72) Inventor: Brian Andrew Digate, Madison, WI (US)

(21) Appl. No.: 19/419,464

(22) Filed: Dec. 15, 2025

(51) Int. Cl. H04L 9/32; H04L 9/00; H04L 9/08

(52) U.S. Cl. CPC H04L 9/3268; H04L 9/0825; H04L 9/3218; H04L 9/3236; H04L 9/3247; H04L 9/50

(57) ABSTRACT

A secure attribution system quantifies human influence in generative AI through integrated decision capture, counterfactual analysis, and cryptographic attestation. A decision capture interface records user interactions including prompts, parameter modifications, and selections within tamper-evident logs. An attribution engine computes contribution scores using counterfactual execution analysis—measuring divergence between user-guided outputs and autonomous baseline outputs—or attention-based token attribution tracing neural network weights. A cryptographic module generates digitally signed certificates containing input logs, computed scores, model metadata, and content hashes. Optional zero-knowledge proofs enable privacy-preserving verification of attribution validity without revealing proprietary inputs. Integration with trusted execution environments provides hardware-isolated security, while distributed ledger integration enables immutable timestamping. This architecture delivers reproducible, cryptographically verifiable provenance for AI-assisted content creation, enabling authentication, regulatory compliance, and trustless marketplace verification while protecting creative trade secrets.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### Field of the Invention

The present invention relates to secure digital content provenance and attribution computing systems. More particularly, the invention relates to cryptographic systems and methods for capturing user interaction data during computational content generation, quantifying causal influence of user inputs on generated outputs through counterfactual execution analysis, and generating tamper-evident digital certificates that cryptographically bind computed attribution metrics to computationally-generated content.

### Description of Related Art

Generative artificial intelligence (AI) systems, including large language models (LLMs), diffusion-based image generators, and multimodal transformers, have achieved remarkable capabilities in autonomous content generation across multiple domains including text, images, audio, video, and executable code. As these technologies proliferate in production environments, there is an increasing technical demand for systems capable of securely computing and preserving provenance information that quantifies human causal contribution to computationally-generated content. Such computing systems are valuable for content authentication, audit trail generation, chain of custody establishment, and downstream integration with content distribution and licensing computing platforms.

Several technical approaches exist for tracking and authenticating digital content, but each suffers from significant limitations when applied to the problem of quantifying and verifying human causal contribution in AI-assisted content generation.

Digital Watermarking Systems. Traditional digital watermarking embeds imperceptible signals into digital content to identify the source or generating system. For example, U.S. Pat. No. 9,940,685 to Tian et al., titled “Authenticating watermarks in color images,” discloses methods for embedding authentication data in color images. Similarly, U.S. Pat. No. 10,572,883 to Boney et al., titled “Watermarking of machine learning models,” describes embedding watermarks in neural network model parameters. However, these watermarking approaches have critical technical limitations: (1) they identify the AI system that generated content but do not capture human input sequences during generation; (2) they provide no quantitative computational metric of human contribution versus autonomous model behavior; (3) they do not record the interactive decision-making process between human and AI; and (4) watermarks can be removed or corrupted through post-generation content modification, making them unsuitable for establishing tamper-evident records of the generation process.

Metadata Embedding Systems. Some systems embed metadata within digital files to track creation parameters. U.S. Pat. No. 10,262,126 to Ptucha et al., titled “Digital media authentication and provenance tracking,” discloses embedding metadata tags in digital media files to track modification history. Adobe's Content Credentials specification (Coalition for Content Provenance and Authenticity, “Content Credentials Technical Specification v2.0,” 2023) defines metadata standards for digital content provenance. While these approaches record basic generation parameters (model version, timestamp, generation settings), they suffer from fundamental technical deficiencies: (1) metadata schemas do not capture sequences of human creative decisions during iterative generation sessions; (2) they provide no analytical framework for computing which portions of generated content resulted from human inputs versus autonomous model behavior; (3) metadata can be trivially modified or stripped from files without cryptographic detection mechanisms; and (4) they lack tamper-evident integrity protection to prevent post-hoc fabrication of provenance claims.

Blockchain-Based Timestamping. Distributed ledger technologies provide immutable timestamp records for digital content. U.S. Pat. No. 10,447,484 to Setty et al., titled “Techniques for maintaining immutable data using a blockchain,” describes recording content hashes on blockchains for timestamp verification. Systems such as Proof of Existence allow users to register document hashes on public blockchains. However, blockchain timestamping addresses only temporal existence and provides no information about generation process details: (1) recording a content hash proves when content existed but provides no data about the generation process; (2) blockchain records do not capture user interactions with generative AI systems; (3) they provide no computational mechanism for distinguishing human-guided content generation from fully autonomous AI generation; and (4) they cannot quantify the degree of human causal contribution to the generation process.

AI Model Explainability Techniques. Research in explainable AI (XAI) has produced computational methods for analyzing AI model behavior. Attention visualization techniques for transformer models, such as those described by Clark et al. (“What Does BERT Look At? An Analysis of BERT's Attention,” BlackboxNLP Workshop, 2019), allow examination of which input tokens a model attends to during generation. Attribution methods like Integrated Gradients (Sundararajan et al., “Axiomatic Attribution for Deep Networks,” ICML 2017) compute the contribution of input features to model outputs through gradient-based analysis. However, these explainability techniques were not designed for and are insufficient for production provenance systems: (1) they analyze model-internal behavior but do not capture human creative decisions during interactive generation sessions; (2) they lack cryptographic integrity mechanisms to create tamper-proof records; (3) they provide no framework for aggregating attribution scores into a unified causal metric comparable against predetermined numerical thresholds; and (4) they are research tools for model analysis, not production systems for generating cryptographically verifiable attribution records.

Content Authentication and Digital Rights Management. Digital rights management (DRM) systems control access to and usage of digital content through cryptographic access controls. U.S. Pat. No. 7,073,063 to Peinado et al., titled “Blockchain-based rights management,” describes using cryptographic techniques to enforce usage rights. Content authentication protocols like C2PA (Coalition for Content Provenance and Authenticity) provide frameworks for asserting content provenance claims. However, these systems focus on protecting and controlling content distribution rather than documenting computational generation processes: (1) DRM systems authenticate content identity but do not record human-AI interaction histories during generation; (2) they lack analytical computing engines for computing quantitative measures of human causal contribution; (3) they do not address the specific technical problem of distinguishing AI-assisted creation from fully autonomous AI generation; and (4) they provide no mechanism for capturing and cryptographically attesting to sequences of human creative inputs during generation sessions.

Prior Art Deficiencies. Conventional systems generally do not combine: (1) comprehensive capture of human creative input sequences during interactive AI-assisted generation sessions; (2) computational counterfactual analysis methods for quantifying human causal influence on generated outputs; (3) cryptographic attestation mechanisms that produce tamper-evident attribution certificates binding computed attribution metrics to generated content; (4) verification protocols enabling third-party validation of computed attribution metrics; and (5) integration architectures for content distribution and licensing computing platforms requiring authenticated provenance data. A search of the prior art has not revealed systems that utilize counterfactual execution analysis—executing generative models with and without human inputs to compute divergence metrics—as a computational method for quantifying human causal contribution to computationally-generated content. Furthermore, prior art systems do not provide privacy-preserving verification mechanisms using zero-knowledge cryptographic proofs that enable third parties to verify attribution scores without accessing sensitive creative inputs.

Accordingly, there exists a substantial and unmet technical need for a comprehensive computing architecture that can: systematically capture human input sequences during AI-assisted content generation; apply rigorous computational methods to quantify the degree of human causal influence on generated outputs; generate cryptographically verifiable attribution certificates providing tamper-evident records of the generation process; enable third-party verification of computed attribution metrics without revealing proprietary generation details through zero-knowledge proof systems; and integrate with downstream computing systems requiring authenticated provenance data.

The present invention addresses these technical deficiencies by providing a novel cryptographic attribution computing system specifically architected for the unique technical challenges of quantifying and verifying human causal contribution in human-AI collaborative content generation workflows, with optional privacy-preserving verification capabilities using zero-knowledge cryptographic proofs.

### BRIEF SUMMARY OF THE INVENTION

The present invention provides systems and methods for generating cryptographically verifiable attribution records that quantify human causal contribution to computationally-generated content through integrated decision capture, attribution analysis, and cryptographic attestation with optional zero-knowledge proof generation.

In one aspect, the invention provides a computing system comprising: a decision capture interface recording human input sequences during AI-assisted generation sessions; an attribution engine computing human influence metrics using counterfactual execution analysis and attention-based token attribution; and a cryptographic attestation module generating tamper-evident certificates binding computed metrics to generated content with optional zero-knowledge proofs enabling privacy-preserving verification.

In another aspect, the invention provides computer-implemented methods for capturing user inputs, executing factual and counterfactual model runs, computing divergence-based attribution scores, generating cryptographically secured attribution records with digital signatures and content hashes, and optionally producing zero-knowledge proofs demonstrating score validity without revealing underlying creative inputs.

The invention enables secure, reproducible, and cryptographically verifiable provenance tracking for AI-assisted content generation across diverse computing applications including content authentication systems, audit trail generation, privacy-preserving regulatory compliance, and integration with external provenance registries and content distribution platforms.

### BRIEF DESCRIPTION OF THE DRAWINGS

FIG. 1 is a system architecture diagram showing major components of the authorship attribution and verification system according to an embodiment of the invention.

FIG. 2 is a flowchart illustrating the method for capturing human creative inputs during an AI-assisted content generation session.

FIG. 3 is a flowchart illustrating the authorship attribution analysis process for computing human influence metrics.

FIG. 4 is a diagram showing the structure of an authorship certificate according to an embodiment of the invention.

FIG. 5 is a flowchart illustrating the cryptographic attestation and certificate generation process.

FIG. 6 is a system diagram showing integration with external provenance registries, publishing platforms, and verification services.

FIG. 7 is a user interface diagram showing real-time authorship feedback during content generation.

FIG. 8 is a flowchart illustrating counterfactual attribution analysis for measuring human influence on output elements.

FIG. 9 is a diagram showing attention-based token attribution for transformer language models.

FIG. 10 is a system architecture diagram showing trusted execution environment implementation.

FIG. 11 is a flowchart illustrating the third-party verification process for authorship certificates.

FIG. 12 is a diagram showing distributed ledger integration for timestamp verification.

FIG. 13 is a diagram showing zero-knowledge proof generation and verification system architecture.

### CORRESPONDENCE BETWEEN DRAWINGS AND CLAIMS

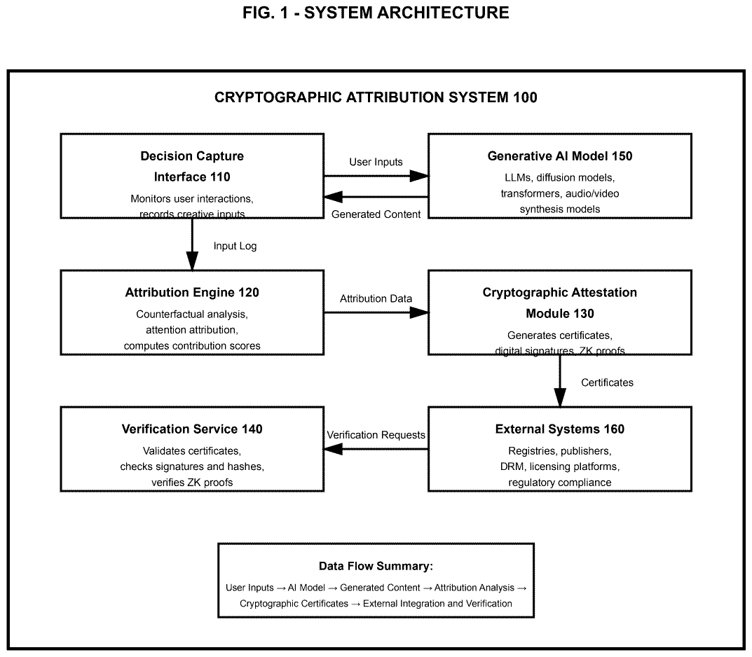

The drawings provide visual illustration of the claim elements and their interrelationships. FIG. 1 illustrates the overall system architecture of claim 1, showing the decision capture interface (110), attribution engine (120), cryptographic attestation module (130), verification service (140), generative AI model (150), and external systems integration (160), along with the data flows between these components.

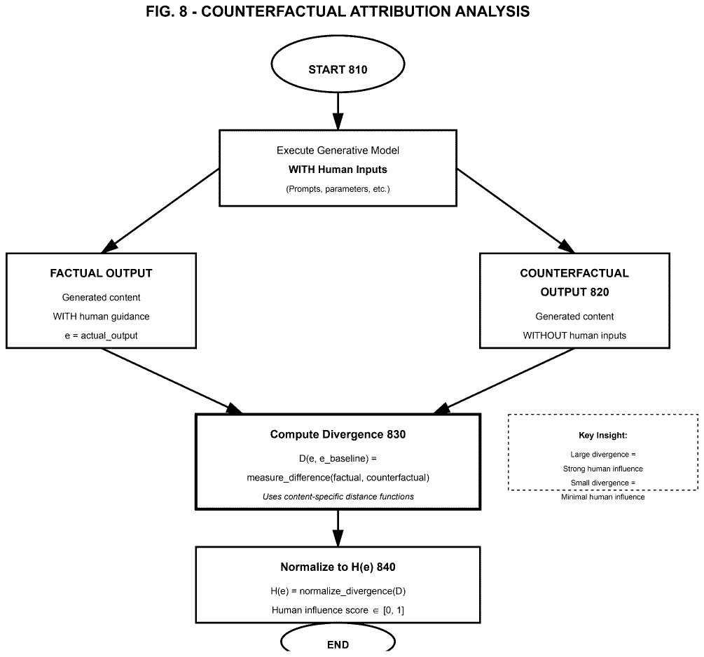

FIG. 8 specifically illustrates the counterfactual attribution analysis technique recited in claims 2 and 3, depicting the parallel execution paths wherein the generative AI model executes with human inputs to produce factual output and without human inputs to produce counterfactual baseline output, followed by divergence computation and normalization to produce human influence metrics.

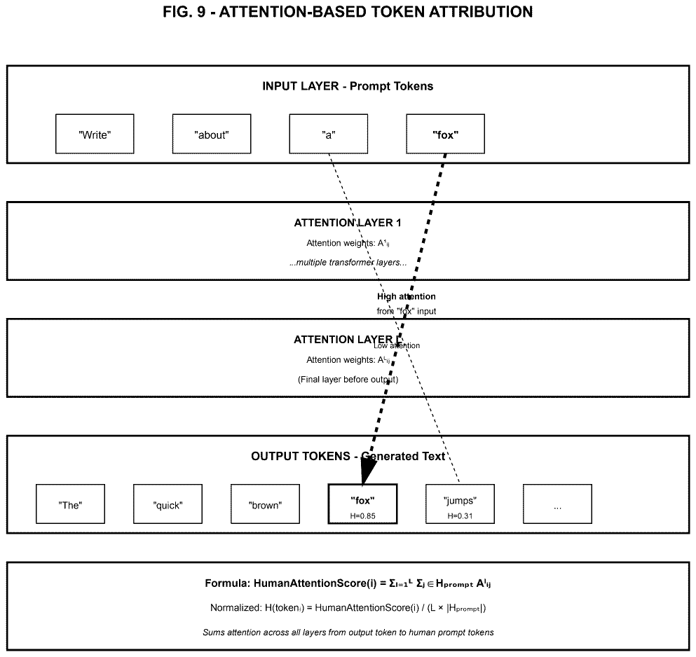

FIG. 9 illustrates the attention-based token attribution technique of claim 4, showing how attention weight matrices from transformer layers are traced from generated output tokens back through network layers to human-provided prompt tokens, with cumulative attention scores computed and normalized to quantify token-level human influence.

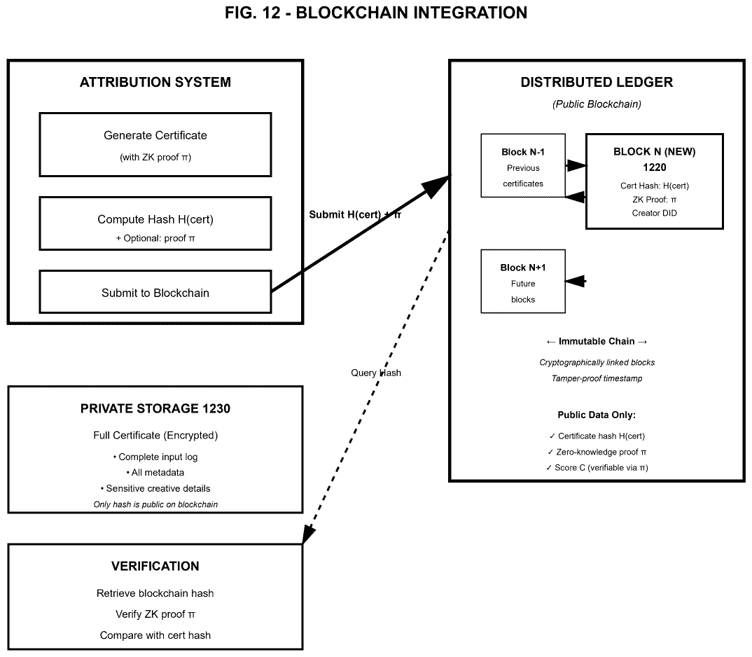

FIG. 12 illustrates the distributed ledger integration of claim 12, depicting how certificate hashes are submitted to blockchain systems for immutable timestamp verification while full certificates remain in private encrypted storage, enabling public verifiability without disclosure of sensitive creative process information.

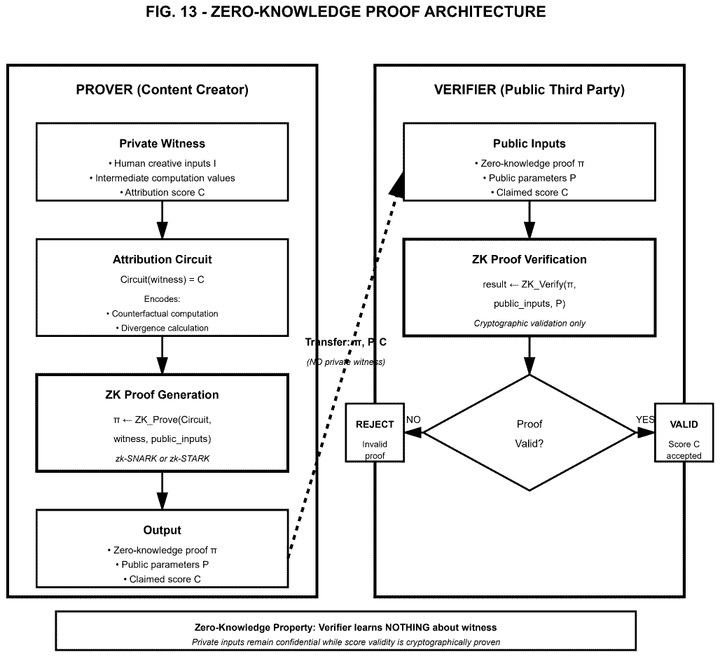

FIG. 13 illustrates the zero-knowledge proof generation and verification architecture referenced in claim 12, showing the prover-verifier relationship wherein the prover (content creator) generates cryptographic proofs demonstrating correct attribution score computation without revealing private creative inputs, and the verifier (public third party) cryptographically validates proof correctness using only public parameters and claimed scores.

The remaining figures provide supporting detail for various system components, processing flows, and alternative embodiments, all of which contribute to enablement under 35 U.S.C. § 112(a) by illustrating multiple implementation approaches and deployment configurations within the scope of the claimed invention.

### DETAILED DESCRIPTION OF THE INVENTION

Referring to FIG. 1, the cryptographic attribution system 100 comprises several major subsystems that work together to capture, analyze, and verify human creative contribution in AI-assisted content generation. The system 100 provides a comprehensive technical solution for documenting and quantifying human causal influence on computationally-generated content through integrated decision capture, attribution analysis, and cryptographic attestation mechanisms.

Terminology Note. As used herein, terms such as “authorship,” “authorship attribution,” and “human contribution” refer to computed technical metrics quantifying human causal influence on generated outputs and do not represent legal determinations of copyright ownership, legal authorship status, or intellectual property rights. The system computes numerical attribution scores based on observable technical factors such as input sequences, model execution parameters, and divergence measurements. Any use of “authorship” terminology should be understood as shorthand for “quantified human contribution metric” rather than a legal conclusion.

Technical Improvement Over Prior Systems. In contrast to conventional content generation systems that lack the ability to distinguish human causal influence from model-derived output, the disclosed attribution techniques introduce a technical mechanism for quantifying human contribution through counterfactual model execution and divergence analysis. This improves the operation of AI-assisted content generation systems by enabling objective attribution, auditability, and post-generation verification that were not previously achievable using existing architectures. The counterfactual execution approach constitutes a specific technical improvement to computer systems rather than an abstract mental process or mathematical formula.

The system 100 includes a decision capture interface 110 that monitors and records all human creative inputs during an interactive content generation session with a generative AI model 150. The generative AI model 150 may comprise any suitable generative model including but not limited to large language models (LLMs), diffusion models for image generation, multimodal transformers, audio synthesis models, video generation models, or any combination thereof. The decision capture interface 110 implements real-time monitoring of user interactions with the AI model 150, capturing a comprehensive log of all creative decisions made during the generation process.

An authorship attribution engine 120 analyzes the recorded human inputs and the generated content to compute quantitative metrics representing the degree of human creative contribution. The attribution engine 120 applies various analytical techniques described in detail below to trace causal relationships between human decisions and output elements. These techniques include counterfactual analysis comparing outputs with and without human inputs, attention-based token attribution for transformer models, modification magnitude analysis for manual edits, and selection attribution for choice operations among multiple candidates.

A cryptographic attestation module 130 generates tamper-proof authorship certificates that package the creative process evidence in a verifiable format suitable for technical verification. The attestation module 130 leverages cryptographic signing using digital signature algorithms, hash functions for content binding, and optionally trusted execution environments or distributed ledgers for enhanced security. In some embodiments, the attestation module 130 may generate zero-knowledge proofs enabling privacy-preserving verification of attribution scores. The certificates produced by the attestation module 130 provide cryptographically authenticated records of the generation process that can be independently verified by third parties.

A verification service 140 provides third-party validation of authorship certificates, enabling external systems to independently verify authorship claims. The verification service 140 implements cryptographic signature validation, content hash verification, attribution score assessment protocols, and optional zero-knowledge proof verification that operate without requiring access to proprietary generation details or sensitive creative process information.

The system 100 may integrate with various external systems 160 including content authentication platforms, provenance registry systems, content publishing platforms, digital rights management (DRM) systems, and licensing computing platforms. These integration points enable the attribution certificates generated by the system to be utilized in downstream workflows requiring authenticated provenance data for AI-assisted content.

### II. Decision Capture Interface

The decision capture interface 110 serves as the primary data collection component of the system, observing, categorizing, and recording every human creative decision made during the content generation process. In various embodiments, the interface 110 may be implemented as a plugin to existing AI content generation tools, as a wrapper application that monitors user interactions with AI models, or as an integrated component of a purpose-built AI content creation platform.

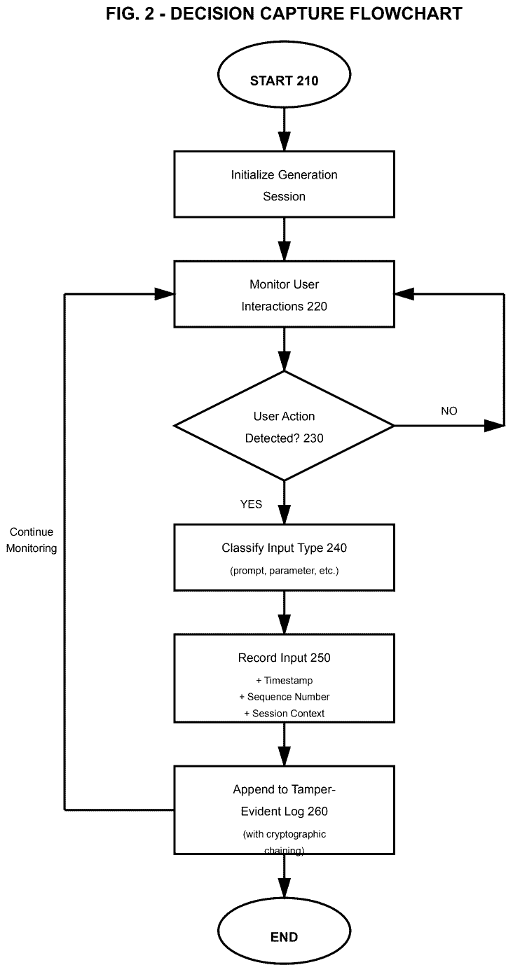

Referring to FIG. 2, in one embodiment, the decision capture process begins at step 210 with initialization of a generation session. During the session, the interface 110 continuously monitors user interactions with the AI model at step 220. When a user action is detected at decision point 230, the interface classifies the input type at step 240, identifying whether the input constitutes a textual prompt, parameter adjustment, selection operation, rejection operation, manual modification, structural arrangement, or other creative input category.

The interface 110 records each classified input at step 250 along with comprehensive metadata including timestamp information with millisecond precision, sequence numbers for ordering, user identity information, session context, and any relevant system state. These records are appended to a tamper-evident creative input log at step 260, which may implement cryptographic chaining where each record includes a hash of the previous record to make any alteration detectable.

In some embodiments, the decision capture interface 110 is configured to recognize and record multiple categories of human creative input. Textual prompt specifications provided by users may be captured in their entirety, including the complete prompt text, timestamp of submission, any special formatting or markup, context from previous prompts in multi-turn conversations, and user-provided examples or demonstrations.

Parameter adjustments to generative AI models may be captured including modifications to temperature or randomness settings controlling output diversity, top-k or top-p sampling parameters, length or size constraints, style or tone specifications, model-specific parameters such as guidance scales in diffusion models, and negative prompts specifying what to avoid.

Selection operations occur when a generative AI model produces multiple candidate outputs and the user chooses which candidate to keep. The interface 110 may record the complete set of all candidates presented, which specific candidate the user selected, which candidates were rejected, the cardinality of the choice set indicating how many options existed, and any user annotations explaining the selection rationale.

Rejection operations where a user rejects all generated outputs and requests regeneration may be captured including the rejected outputs themselves, the regeneration request, and any modifications to prompts or parameters accompanying the rejection.

Manual modifications where users directly edit or modify AI-generated content may be recorded by capturing the original AI-generated element before modification, the modified version after human editing, the magnitude and nature of changes whether text edits, image manipulations, or audio adjustments, and timestamps of modification actions.

Structural arrangements where users arrange and compose multiple AI-generated elements may be captured by recording the set of elements being arranged, the spatial, temporal, or hierarchical arrangement structure, layout decisions and transitions, and the creative logic behind arrangement decisions.

In one embodiment, for each captured creative input, the interface 110 creates a structured record containing a timestamp with UTC datetime and millisecond precision, an input type enumeration identifying the category of input, input-specific data structures containing the relevant parameters and content, a snapshot of relevant system state providing context, an authenticated user identifier, a unique session identifier, and a monotonically increasing sequence number. These records may be stored in a tamper-evident log structure that employs cryptographic chaining for integrity protection.

### III. Authorship Attribution Engine

The authorship attribution engine 120 addresses the fundamental technical challenge of quantifying human creative contribution to AI-generated content. Given a generated creative work and a log of human creative inputs, the engine computes metrics indicating how much of the work can be attributed to human creativity versus autonomous AI model behavior.

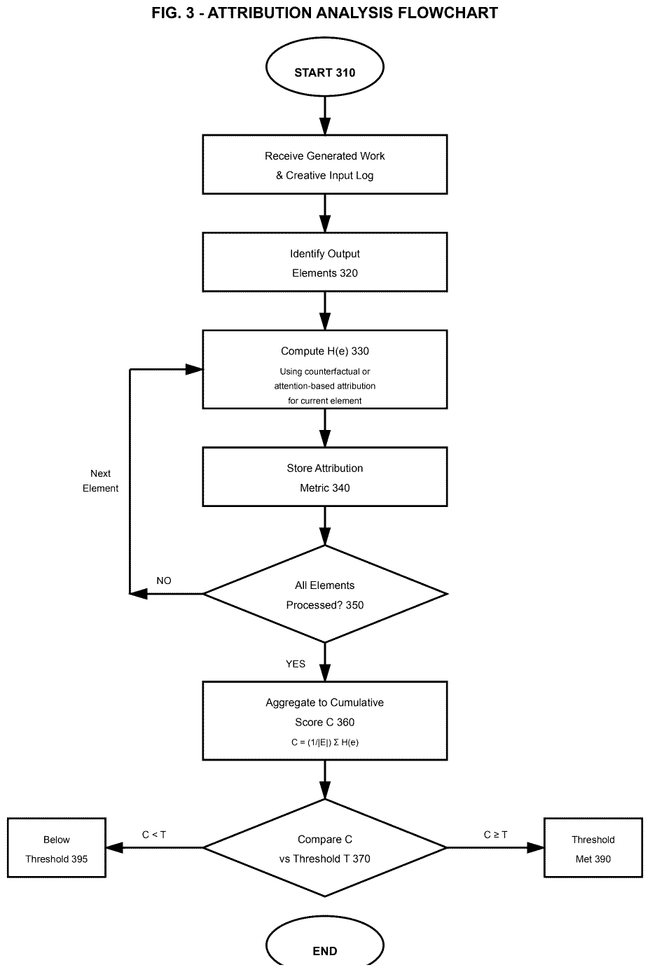

Referring to FIG. 3, in one embodiment, the attribution analysis process begins at step 310 with receipt of a generated work and the creative input log. At step 320, the engine identifies output elements in the generated work, where elements may be defined at various granularities depending on content type: individual tokens, sentences, or paragraphs for text; regions, objects, or pixels for images; time segments or frequency bands for audio; frames or scenes for video; or functions, classes, or logical blocks for code.

For each output element, the engine computes a human influence metric H(e) at step 330 quantifying the degree to which that element resulted from human creative inputs versus autonomous AI generation. Multiple techniques for computing H(e) are available and may be selected based on content type and model architecture. The computed metrics are stored at step 340 for subsequent aggregation.

In some embodiments, model-agnostic attribution techniques may be employed that treat the generative AI model as a black box without requiring access to internal model parameters, gradients, or attention weights. Such model-agnostic approaches may include perturbation-based analysis where inputs are systematically varied and output changes are measured, surrogate model approximation where a simpler interpretable model approximates the generative model's behavior for attribution purposes, or input ablation studies where subsets of human inputs are removed and output differences are quantified. These model-agnostic techniques ensure the attribution system remains applicable even when internal model details are proprietary or inaccessible.

After processing all elements as determined at decision point 350, the engine aggregates the individual human influence metrics to compute a cumulative score C at step 360. This aggregation may employ simple averaging, weighted averaging based on element importance, or more sophisticated aggregation formulas accounting for element interactions.

The cumulative score C is compared against a predetermined threshold T at step 370. If C exceeds T at decision point 380, the output indicates the contribution score meets the configured threshold at step 390. If C falls below T, the output indicates the contribution score is below the configured threshold at step 395. The threshold T represents the minimum level of human creative contribution required for the intended application, which may be configured based on content type, application-specific requirements, or user preferences.

### IV. Counterfactual Attribution Analysis

Referring to FIG. 8, counterfactual attribution analysis provides a computational method for measuring human influence on generated outputs. In one embodiment, the technique operates by comparing what the AI model actually generated with human inputs against what it would have generated without those inputs, thereby isolating the causal effect of human creative decisions.

The counterfactual attribution algorithm may be implemented according to the following pseudocode:

Algorithm 1: Counterfactual Attribution Analysis

Input: generated_element e, human_inputs H, ai_model M, baseline_config B
Output: human_influence_score H(e)

| | |
|---|---|
| 1. | // Execute model with human inputs (factual) |
| 2. | factual_output ← execute_model(M, H) |
| 3. | |
| 4. | // Execute model without human inputs (counterfactual) |
| 5. | counterfactual_output ← execute_model(M, B) |
| 6. | |
| 7. | // Compute divergence between outputs |
| 8. | D ← compute_divergence(factual_output, counterfactual_output) |
| 9. | |
| 10. | // Normalize to [0,1] range |
| 11. | H(e) ← normalize_divergence(D) |
| 12. | |
| 13. | return H(e) |

In some embodiments, the counterfactual attribution algorithm is executed by the attribution engine 120 comprising one or more processors and memory devices storing executable instructions. The execute_model operations invoke a trained generative model stored in non-volatile memory, with model parameters loaded into processor cache for computational efficiency. The divergence computation is performed using numerical comparison routines executed by the processor, with intermediate results stored in volatile memory. Vector representations of outputs are generated using matrix multiplication operations performed by specialized computational units such as GPUs or tensor processing units where available, with distance metrics computed using floating-point arithmetic units of the processor.

At step 810, the attribution engine may execute the generative AI model with the recorded human creative inputs to generate the actual output element e. This represents the factual outcome that resulted from the human-AI collaboration. The execution may use the same generation parameters as were used during the original generation session to ensure reproducibility.

At step 820, the engine may execute the same generative AI model without the human inputs or with those inputs masked or replaced with neutral defaults to generate a baseline output element e_baseline. This baseline represents the counterfactual outcome showing what the AI would have generated autonomously without human guidance. In some embodiments, partial counterfactual analysis may be performed by selectively masking subsets of human inputs rather than all inputs simultaneously, enabling per-decision attribution where the causal contribution of individual creative decisions is isolated, staged counterfactual analysis where inputs from different temporal stages are ablated separately, or hierarchical attribution where high-level decisions such as prompts are distinguished from low-level refinements such as parameter adjustments. Such partial counterfactual analysis provides fine-grained attribution at the individual decision level.

At step 830, the engine may compute a divergence measure D (e, e_baseline) quantifying how different the actual output e is from the baseline output e_baseline. In some embodiments, the divergence computation includes generating vector representations of the factual and counterfactual outputs and computing a distance metric selected from cosine distance, Kullback-Leibler divergence, token-level edit distance, or Wasserstein distance. For text content, the divergence may be computed as:

D_text(e,e_baseline)=LevenshteinDistance(e,e_baseline)/max(|e|,|e_baseline|)

where LevenshteinDistance computes the minimum number of single-character edits required to transform one string into another, and |e| denotes the length of string e. The computation requires programmatic execution of dynamic programming algorithms operating on character-level representations stored in memory arrays.

Alternatively, semantic divergence may be computed using embedding-based similarity:

D_semantic(e,e_baseline)=1−cosine_similarity(embed(e),embed(e_baseline))

where embed(·) produces a dense vector representation using models such as BERT or sentence transformers.

For image content, the divergence may be computed using multiple metrics:

D_pixel(e,e_baseline)=(1/N)Σ_i∥e_i−e_baseline_i∥²

where N is the total number of pixels and e_i represents the pixel value at position i. Structural similarity may be computed as:

D_SSIM(e,e_baseline)=1−SSIM(e,e_baseline)

where SSIM is the Structural Similarity Index measuring perceptual similarity.

Perceptual distance using deep neural networks may be computed as:

D_perceptual(e,e_baseline)=∥φ(e)−φ(e_baseline)∥²

where φ(·) represents features extracted from intermediate layers of a pre-trained network such as VGG or ResNet.

For audio content, mel-frequency cepstral coefficients (MFCC) distance may be computed as:

D_audio(e,e_baseline)=(1/T)Σ_t∥MFCC(e)_t−MFCC(e_baseline)_t∥²

where T is the number of time frames and MFCC(·)_t represents the MFCC features at time frame t.

At step 840, the engine may convert the divergence measure into a human influence metric H(e) using a monotonically increasing function such that greater divergence indicates greater human influence. Sigmoid normalization may use the formula:

H(e)=1/(1+exp(−k(D−D₀)))

where:
k=steepness parameter controlling the sharpness of the transition
D=measured divergence value
D₀=midpoint threshold representing 50% attribution
   The sigmoid function produces a smooth S-shaped curve mapping divergence values to the range [0, 1].

Linear normalization may use the formula:

H(e)=min(D/D_max,1.0)

where D_max represents a maximum expected divergence value. This produces a linear mapping up to the maximum, after which the score is capped at 1.0.

Piecewise linear normalization may define different slopes for different divergence ranges:

H(e) = {

| | |
|---|---|
| 0, | if D < D_min |
| (D − D_min)/(D_mid − D_min) × 0.5, | if D_min ≤ D < D_mid |
| 0.5 + (D − D_mid)/(D_max − D_mid) × 0.5, | if D_mid ≤ D < D_max |
| 1.0, | if D ≥ D_max |

}

where D_min, D_mid, and D_max define transition points in the divergence range.

As a non-limiting example, if a user provides a detailed prompt describing “a sunset over a mountain lake with purple clouds and a wooden dock” and the AI generates an image matching that description, while the same AI model with a generic prompt “generate an image” produces a completely different scene, the large divergence may indicate high human influence through the prompt specification. Conversely, if both prompts produce similar outputs, the low divergence suggests minimal human influence.

The counterfactual execution step requires executing the generative model under a modified configuration that suppresses or excludes human inputs, which cannot be performed mentally and requires programmatic control of model parameters and execution pathways. Unlike conventional analytical techniques that operate on static data, counterfactual execution dynamically invokes the generative model's inference engine multiple times with different input configurations, requiring computational resources including processor cycles, memory allocation, and model parameter access. This computational approach distinguishes the invention from abstract analytical concepts and constitutes a specific technical improvement to AI content generation systems by enabling quantitative measurement of human causal contribution through controlled model execution experiments.

### V. Attention-Based Token Attribution

Referring to FIG. 9, attention-based token attribution provides a technique for transformer-based language models that leverages the interpretability of attention mechanisms. This approach may trace which input tokens each generated token attended to during generation, enabling measurement of human influence based on attention flow from human-provided prompts to generated outputs.

The attention-based attribution algorithm may be implemented according to the following pseudocode:

Algorithm 2: Attention-Based Token Attribution

Input: generated_tokens G, prompt_tokens P, attention_weights A, num_layers L
Output: attribution_scores H for each token in G

| | |
|---|---|
| 1. | // Initialize attribution scores |
| 2. | H ← zero_vector(length(G)) |
| 3. | |
| 4. | // Identify prompt token positions |
| 5. | H_prompt ← indices_of(P) |
| 6. | |
| 7. | // For each generated token |
| 8. | for i = 1 to length(G) do |
| 9. | score ← 0 |
| 10. | |
| 11. | // Sum attention across all layers and prompt positions |
| 12. | for l = 1 to L do |
| 13. | for j in H_prompt do |
| 14 | score ← score + A[l][i][j] |
| 15. | end for |
| 16. | end for |
| 17. | |
| 18. | // Normalize by layers and prompt length |
| 19. | H[i] ← score / (L × \|H_prompt\|) |
| 20. | end for |
| 21. | |
| 22. | return H |

In one embodiment, the technique begins by identifying the set of tokens in the generated work G={g₁, g₂, . . . , g_n} and the set of tokens in the human-provided prompt P={p₁, p₂, . . . , p_m}. For each generated token at position i, the attribution engine may trace attention weights backward through the transformer layers to identify which input tokens the model attended to when generating that specific output token.

The engine may retrieve attention weight matrices A\hat{ }l from each transformer layer l∈{1, 2, . . . , L}, where A\hat{ }l_ij represents the attention weight from output token at position i to input token at position j in layer l. Modern transformer models typically expose these attention weights through their internal state or API interfaces for analysis and visualization purposes.

The set of prompt token positions H_prompt⊆{1, 2, . . . , m} may be identified, representing all tokens in the human-provided prompt as distinguished from model-generated tokens in multi-turn scenarios. For a single-turn generation, H_prompt includes all input positions: H_prompt={1, 2, . . . , m}.

The cumulative attention to human tokens may be calculated by summing attention weights across all layers and prompt positions:

HumanAttentionScore(i)=Σ_{l=1}\hat{ }LΣ_{j∈H_prompt}A\hat{ }l_ij

where:
L=total number of transformer layers
H_prompt=set of prompt token indices
A\hat{ }l_ij=attention weight from output position i to input position j in layer l

This raw attention score may be normalized to produce the human attribution metric H(token_i)∈[0, 1] by dividing by the total number of layers and the number of prompt tokens:

H(token_i)=HumanAttentionScore(i)/(L×|H_prompt|)

where |H_prompt| denotes the cardinality of the prompt token set.

For multi-head attention architectures where each layer contains H attention heads, the calculation may extend to sum across all heads:

HumanAttentionScore(i)=Σ_{l=1}\hat{ }LΣ_{h=1}\hat{ }HΣ_{j∈H_prompt}A\hat{ }{l,h}_ij

where A\hat{ }{l,h} _ij represents the attention weight from head h in layer l. The normalization formula adjusts accordingly:

H(token_i)=HumanAttentionScore(i)/(L×H×|H_prompt))

In some embodiments, weighted attention attribution may assign different importance to different layers. Deep layers closer to the output may be weighted more heavily than early layers:

HumanAttentionScore(i)=Σ_{l=1}\hat{ }L w_lΣ_{j∈H_prompt}A\hat{ }_ij

where w_l represents the weight for layer l, which may follow patterns such as:
Linear weighting: w_l=l/L
Exponential weighting: w_l=exp(α(l−1))/Σ_l exp(a (1-1))
Top-layer emphasis: w_l=l if 1>L/2, else 0.5

The attention-based approach may provide advantages for transformer models including direct interpretability since attention mechanisms explicitly show which inputs influenced which outputs, computational efficiency since attention weights are already computed during generation and do not require additional model executions, and fine-grained attribution at the token level enabling detailed analysis of human influence patterns.

As a non-limiting example implementation, consider a generated sentence: “The quick brown fox jumps over the lazy dog.” If the human prompt was “Write a sentence about a fox,” the attention analysis might reveal:
Token “fox”: H(fox)=0.85 (high attention to “fox” in prompt)
Token “quick”: H(quick)=0.42 (moderate attention to prompt context)
Token “brown”: H(brown)=0.38 (moderate attention to prompt context)
Token “jumps”: H(jumps)=0.31 (lower attention, more autonomous generation)
   These scores quantify how much each generated token was influenced by the human-provided prompt versus autonomous model completion.

### VI. Manual Modification Attribution

In some embodiments, when users directly edit or modify AI-generated content, the attribution engine may compute influence metrics based on modification magnitude. Direct manual editing represents clear human authorship since the user is directly creating portions of the final work.

The modification magnitude M may be computed as a normalized measure of the degree of alteration between the original AI-generated element and the manually modified element:

M=distance(original,modified)/max_possible_distance

where the distance function and maximum possible distance depend on content type.

For text content, edit distance normalized by content length may be computed as:

M_text=LevenshteinDistance(original,modified)/max(|original|,|modified|)

where LevenshteinDistance computes the minimum number of single-character edits (insertions, deletions, substitutions) required to transform the original into the modified version, and |·| denotes string length.

For image content, pixel-level modification percentage may be computed as:

M_image=|{pixels changed}|/|{total pixels}|

where pixels are considered “changed” if the absolute difference exceeds a threshold t:

```
pixel_changed(p) = {
  1, if ||original(p) − modified(p)|| > τ
  0, otherwise
}
```

Alternatively, weighted modification based on change magnitude may be used:

M_image=(Σ_p∥original(p)−modified(p)∥)/(Σ_p∥max_intensity−min_intensity∥)

For code content, both line changes and functional modifications may be weighted:

M_code=(a×lines_changed+β×functions_modified)/(α×total_lines+β×total_functions)

where α and β are configurable weighting factors.

The human influence metric H(element) may be computed from modification magnitude M using threshold-based attribution:

```
H(element) = {
  1.0, if M ≥ T_substantial
  M / T_substantial, if M < T_substantial
}
```

where T_substantial represents a threshold for “substantial modification”. This step function provides full human attribution for substantial edits and proportional attribution for minor modifications.

Alternative formulations may use smooth transitions. A sigmoid-based attribution may be computed as:

H(element)=1/(1+exp(−k(M−T_substantial)

where k controls the steepness of the transition around the threshold.

### VII. Selection Attribution

In some embodiments, when users select one candidate from multiple AI-generated alternatives, the attribution engine may assign creative authorship weight based on the selection operation itself. Selection among alternatives represents aesthetic and conceptual judgment requiring human discrimination and decision-making.

For a selection operation where the user chooses one candidate from N generated alternatives, the human influence metric may be computed using logarithmic scaling:

H(selected)=base+α×log₂(N)

where:
base=baseline attribution value for making any selection
α=scaling factor
N=number of candidates in the choice set

The formula is capped at a maximum value to maintain the [0, 1] range:

H(selected)=min(base+α×log₂(N),1.0)

The logarithmic scaling reflects information theory principles: choosing from a larger set of alternatives demonstrates more bits of information in the selection decision. The relationship is:

Information(selection)=log₂(N) bits

In some embodiments, selection attribution may be enhanced by considering candidate diversity. If the N candidates are highly similar, the selection carries less information than if they are highly diverse:

H(selected)=min(base+α×log₂(N)×diversity_factor,1.0)

where diversity_factor∈[0, 1] is computed based on pairwise distances between candidates:

diversity_factor=(Σ_{i<j}distance(candidate_i,candidate_j))/(N(N−1)/2×max_distance)

This approach recognizes that selecting from a set of diverse alternatives requires more aesthetic judgment than selecting from a set of near-identical alternatives, even if the cardinality N is the same.

### VIII. Cumulative Score Aggregation

After computing human influence metrics H(e) for individual elements, the attribution engine may aggregate these into a cumulative human contribution score C for the entire creative work. Multiple aggregation approaches may be employed depending on the nature of the content and the uniformity of element importance.

The aggregation algorithm may be implemented according to the following pseudocode:

Algorithm 3: Cumulative Score Aggregation

Input: element_scores H = {H(e₁), H(e₂), ..., H(e_n)},

element_weights w = {w(e₁), w(e₂), ..., w(e_n)}

Output: cumulative_score C

| | |
|---|---|
| 1. | if all_weights_equal(w) then |
| 2. | // Simple arithmetic mean |
| 3. | C ← (Σ_{i=1}\hat{ }n H(e_i)) / n |
| 4. | else |
| 5. | // Weighted mean |
| 6. | C ← (Σ_{i=1}\hat{ }n w(e_i) × H(e_i)) / (Σ_{i=1}\hat{ }n w(e_i)) |
| 7. | end if |
| 8. | |
| 9. | // Ensure C is in [0,1] range |
| 10. | C ← max(0, min(C, 1)) |
| 11. | |
| 12. | return C |

In one embodiment, basic aggregation may compute the arithmetic mean:

C=(1/|E|)Σ_{e∈E}H(e)

where:
E=set of all output elements
   |E|=cardinality of set E (total number of elements)
H(e)=human influence score for element e
   This simple average treats all elements as equally important and yields a score in the range [0, 1], where 0 indicates purely AI-generated content and 1 indicates fully human-authored content.

In another embodiment, weighted aggregation may account for varying element importance:

C=(Σ_{e∈E}w(e)×H(e))/(Σ_{e∈E}w(e))

where w(e) represents the importance weight for element e. The weights must satisfy w(e)>0 for all e, and are normalized such that Σ_{e∈E} w(e) represents the total weight.

Weights may be assigned based on various criteria:

```
(a) Size-based weighting for text:
  w(e) = word_count(e)
(b) Size-based weighting for images:
  w(e) = pixel_count(e) or area(e)
(c) Duration-based weighting for audio/video:
  w(e) = duration_seconds(e)
(d) Perceptual importance (user-specified or computed):
  w(e) ∈ {1, 2, 3, 4, 5} representing importance levels
(e) Content significance (e.g., titles, key claims):
  w(e) = {
    2.0, if e is title or key element
    1.0, otherwise
  }
```

For multimedia works containing multiple modalities (text, image, audio, video), separate contribution scores may be computed for each modality and combined using weighted aggregation:

C_total=Σ_{m∈M}w_m×C_m

where:
M=set of modalities present in the work
C_m=contribution score for modality m
w_m=weight for modality m
Σ_{m∈M} w_m=1 (weights sum to 1)

In some embodiments, temporal breakdown may segment the generation session into stages S={s₁, s₂, . . . , s_k} and compute stage-specific scores C(s_i) for each stage. The temporal profile may be represented as:

TemporalProfile={(t₁,C(s₁)),(t₂,C(s₂)), . . . ,(t_k,C(s_k))}

where t_i is the timestamp or stage identifier. This demonstrates iterative human involvement throughout the creative process rather than just initial prompting or final editing.

The overall score may aggregate stage scores using weighted temporal averaging:

C=Σ_{i=1}\hat{ }k w(s_i)×C(s_i)

where w(s_i) may be based on:
Stage duration: w(s_i)=duration (s_i)/total_duration
Recency weighting: w(s_i)=exp(α·i)/Σ_j exp(α·j) giving more weight to later stages
Uniform weighting: w(s_i)=1/k for all stages

### IX. Threshold Determination and Comparison

The attribution engine may compare the cumulative human contribution score C against a predetermined authorship threshold T to determine whether human contribution is sufficient for the intended application. The threshold T represents the minimum level of human creative contribution required and may be configured based on various factors.

In various embodiments, threshold configuration may consider multiple factors. Content type may influence thresholds as different creative domains may have different requirements. Application-specific requirements may vary, with different downstream systems or use cases specifying different threshold values. The system may maintain configurable threshold parameters that can be adjusted based on the specific application context rather than encoding fixed values tied to external standards.

In various embodiments, threshold values may be configured in multiple ways to accommodate diverse application requirements. Thresholds may be implemented as static values preset during system configuration, dynamic values adjusted based on observed acceptance patterns from downstream systems, or adaptive values that evolve through machine learning from user feedback and verification outcomes. Different threshold values may be specified for different content types, with text-based content potentially requiring different contribution levels than image or multimedia content. Jurisdictional variations may necessitate different thresholds, as regulatory requirements for AI transparency and disclosure vary across legal regimes. Application-specific contexts such as commercial licensing platforms, regulatory compliance systems, academic attribution tracking, or personal creative documentation may each warrant distinct threshold configurations. The system may maintain multiple concurrent threshold configurations, enabling simultaneous evaluation of the same generated content against different sufficiency criteria for parallel downstream workflows.

In some embodiments, a safety margin may be applied to configured threshold values:

T=T_configured×(1+safety_margin)

where safety_margin may be a configurable parameter. The final threshold may be bounded at configurable limits:

T=max(T_min,min(T_calculated,T_max))

where T_min and T_max are system configuration parameters.

Dynamic threshold adjustment may, in some embodiments, analyze historical acceptance patterns. If works with certain score ranges are consistently accepted by target systems, threshold values may be adjusted accordingly. This empirical approach may allow the system to adapt thresholds based on observed acceptance patterns rather than predetermined rules.

The threshold exceedance determination may perform the comparison:

if C≥T then threshold_met=TRUE,else threshold_met=FALSE

This Boolean result may drive downstream actions including whether to issue an authorship certificate, whether to allow submission to external systems, or whether to display notifications to users.

### X. Cryptographic Attestation and Certificate Generation

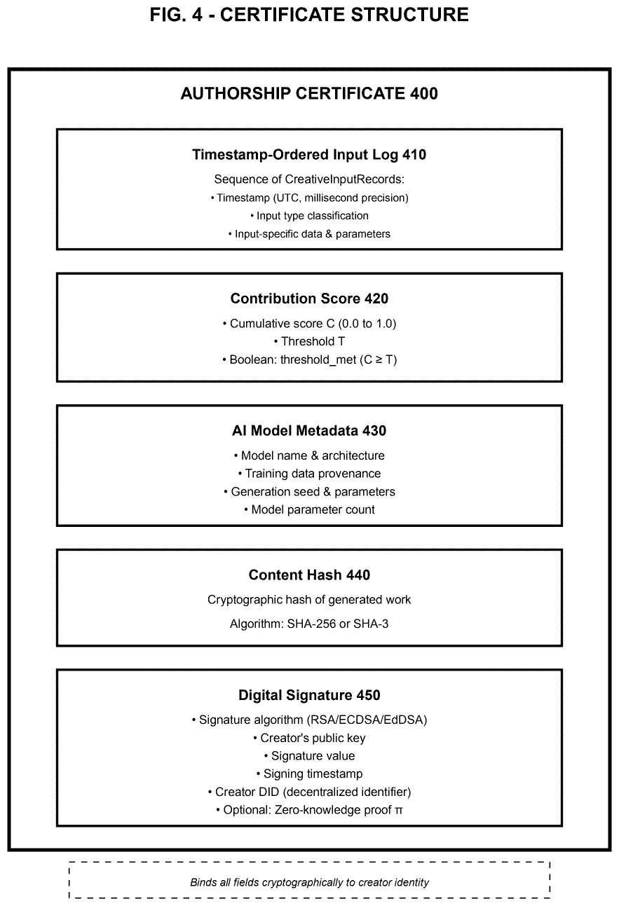

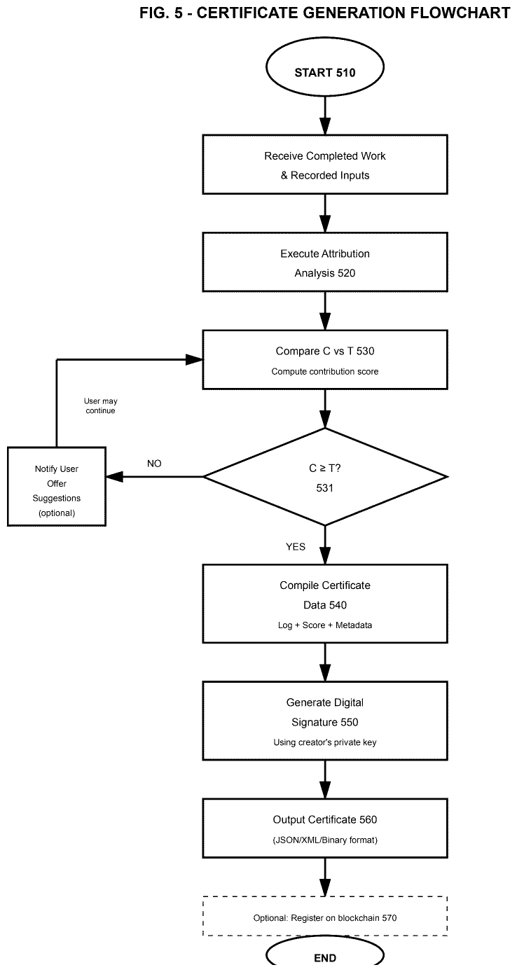

Referring to FIGS. 4 and 5, the cryptographic attestation module 130 may generate authorship certificates that serve multiple purposes: providing verifiable records of the generation process, enabling third-party authentication without requiring trust in the certificate holder, preventing post-hoc alteration of creative process records or contribution scores, protecting privacy through optional zero-knowledge proofs, and allowing selective disclosure of generation details.

In one embodiment, the authorship certificate 400 may comprise several data fields. A timestamp-ordered log 410 may contain the sequence of CreativeInputRecords captured by the decision capture interface, ordered chronologically. The log structure may preserve a record of the creative process. For privacy reasons, users may choose to include only metadata such as timestamps, input types, and magnitudes without full content details.

A cumulative human contribution score field 420 may store the aggregated contribution score C computed by the attribution engine, the threshold T used for comparison, and a Boolean indicating whether C exceeds T. This score may serve as a primary metric for sufficiency determination.

Metadata identifying the generative AI model 430 may include model name and architecture, training data provenance information, model parameter statistics including parameter count, a generation randomness seed used during content generation, and sampling parameters. The generation seed may enable third parties to reproduce the generation process and verify that the recorded inputs would produce the claimed output.

A cryptographic hash of the generated creative work 440 may use algorithms such as SHA-256 or SHA-3 to produce a fixed-size digest. This hash may bind the certificate to the specific creative work, preventing the certificate from being used to authenticate a different work.

A digital signature 450 generated using the creator's private key may include the signature algorithm, the creator's public key for verification, the signature value itself, a signing timestamp, and creator identity information such as a decentralized identifier (DID). The signature may bind the entire certificate to the creator's identity and prevent tampering.

Optionally, the certificate may include a zero-knowledge proof field 460 containing a cryptographic proof demonstrating that the attribution score was correctly computed from valid inputs without revealing the content of those inputs. The zero-knowledge proof enables privacy-preserving verification as described in Section XVIII below.

Referring to FIG. 5, in one embodiment, the certificate generation process 500 may begin at step 510 with receipt of the completed creative work and recorded creative inputs from the decision capture interface. At step 520, the system may execute authorship attribution analysis to compute contribution score C.

At step 530, the system may compare C against threshold T. If C is below T at decision point 531, the system may optionally notify the user and offer suggestions to increase contribution. The user may choose to continue working to increase their contribution or proceed with the current contribution level, which results in a certificate that documents the actual contribution level achieved.

At step 540, the system may compile the certificate data structure including the creative input log, contribution score, AI model metadata, content hash, and optionally a zero-knowledge proof. At step 550, the system may generate a digital signature over the certificate data using the creator's private signing key. At step 560, the completed authorship certificate may be output in a standardized format such as JSON, XML, or a binary encoding.

Optionally at step 570, the certificate hash and any zero-knowledge proof may be registered on a distributed ledger for timestamp proof and public verifiability, providing additional evidence of when the certificate was created.

### XI. Trusted Execution Environment Implementation

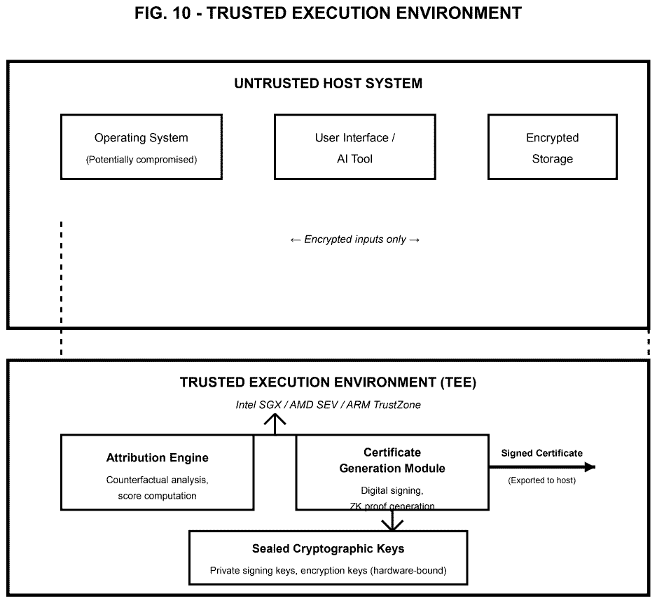

Referring to FIG. 10, in some embodiments, the cryptographic attestation module 130 may be implemented within a hardware-isolated trusted execution environment (TEE) such as Intel SGX, AMD SEV, or ARM TrustZone to provide enhanced security guarantees. TEE implementation may ensure that even if the host system is compromised, the attribution computation and certificate generation processes remain secure and tamper-proof.

The host system may operate in an untrusted environment and may include the operating system, a user interface for content display and input controls, an AI generation tool for model inference and content generation, and an untrusted portion of the decision capture interface that monitors user actions and forwards data to the TEE.

Creative inputs may be encrypted before leaving the TEE and stored in untrusted memory where they cannot be accessed without proper decryption. Decryption keys may be sealed within the TEE hardware and not exposed to external software.

The TEE may contain the core attribution engine including the trusted portion of decision capture, authorship attribution algorithms, score computation logic, certificate generation procedures, zero-knowledge proof generation if enabled, and digital signing operations. Computation may occur in the secure enclave, isolated from the potentially compromised host system.

Sealed cryptographic keys stored in the TEE may include the private signing key which does not leave the TEE and is bound to hardware, encryption keys for encrypting data at rest that are sealed to the TEE hardware, and zero-knowledge proof generation parameters that remain protected within the enclave.

In one embodiment, operational flow with TEE may begin when human creative inputs are captured and immediately encrypted before storage in untrusted memory. Encrypted inputs may be passed into the TEE for attribution analysis where all attribution computation occurs within the TEE. Certificate generation, optional zero-knowledge proof generation, and signing may occur entirely within the TEE, and only the signed certificate and public proof may be exported from the TEE to the host system.

This architecture may provide security properties including tamper resistance where external software cannot alter or inspect code running in the TEE; key protection where cryptographic signing keys are sealed to TEE hardware; proof integrity where zero-knowledge proofs are generated in a trusted environment; and attestation where the TEE can prove to third parties that the authorship attribution software is running in a genuine, unmodified TEE using remote attestation protocols.

### XII. Distributed Ledger Integration

Referring to FIG. 12, in some embodiments, the system may integrate with distributed ledger technologies (blockchains) to provide immutable timestamp verification and public verifiability of certificate existence without revealing private generation details.

At step 1210, after generating an authorship certificate, the system may compute a cryptographic hash H(cert) of the complete certificate using SHA-256 or similar cryptographic hash function. This hash may serve as a compact fingerprint of the entire certificate.

If zero-knowledge proofs are enabled, the system may optionally generate a zero-knowledge proof π demonstrating that the cumulative human contribution score was correctly computed from the recorded human creative inputs without revealing the content of said inputs. The proof generation process is described in detail in Section XVIII below.

At step 1220, the system may submit a transaction to a distributed ledger such as Ethereum, Polygon, or a specialized content registry blockchain. The transaction may record a data structure containing the certificate hash, the optional zero-knowledge proof if generated, creator identifier such as a public key hash or decentralized identifier (DID), timestamp derived from the block timestamp, content type descriptor, and a unique transaction identifier.

The blockchain transaction may be included in a block which is cryptographically linked to previous and subsequent blocks, creating an immutable chain. Once confirmed with multiple subsequent blocks, the timestamp may become practically impossible to alter or backdate. The inclusion of the zero-knowledge proof in the blockchain transaction enables any third party to verify score validity without accessing private creative inputs.

At step 1230, the full authorship certificate may be stored in private encrypted storage which may be local encrypted storage, cloud storage with encryption, or distributed file systems with encryption keys held privately by the creator. The blockchain may contain only the hash and optional proof, not the full certificate, preserving privacy of creative process details while enabling public verification.

For verification, a third-party verifier may receive the certificate and blockchain transaction ID. The verifier may query the blockchain to retrieve the stored hash H(cert), optional zero-knowledge proof π, and timestamp. The verifier may compute the hash of the received certificate and compare hashes. If the computed hash matches the blockchain-stored hash, the certificate may be authenticated as existing at the recorded timestamp. If a zero-knowledge proof is present, the verifier may cryptographically verify the proof to confirm score validity without accessing private inputs.

Benefits of blockchain integration with optional zero-knowledge proofs may include immutable timestamp proof, public verifiability where anyone can verify certificate existence and score validity at a specific time without accessing the full certificate or private inputs, privacy preservation since only the hash and proof are public while sensitive creative process details remain confidential, trustless verification where mathematical certainty replaces trust requirements, and decentralization where no single authority controls the timestamp or verification record.

### XIII. Real-Time Authorship Feedback

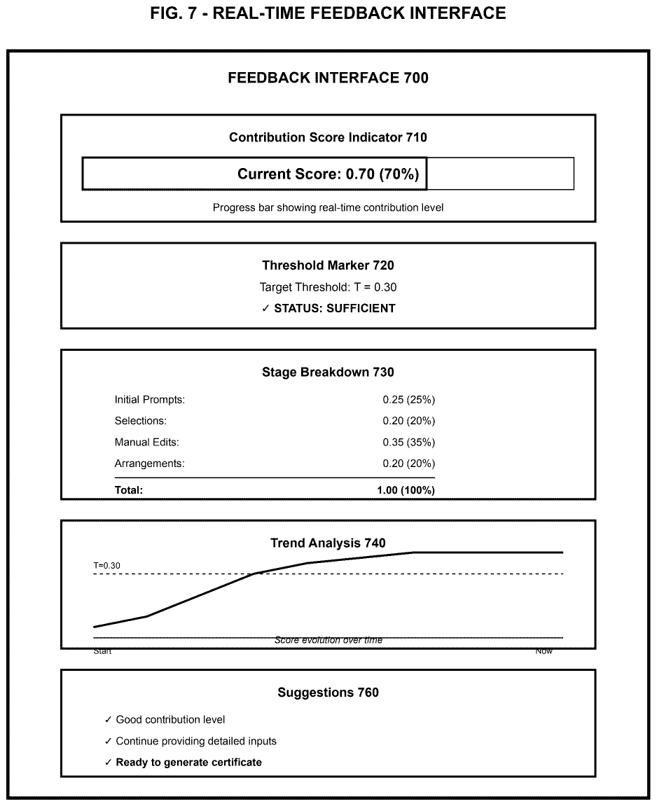

Referring to FIG. 7, in some embodiments, the system may provide real-time feedback to users during content generation sessions, displaying evolving contribution scores and providing proactive guidance. The feedback interface 700 may include a contribution score indicator 710 showing the current cumulative contribution score C as it evolves during the session, typically displayed as a progress bar, percentage, or color-coded gauge.

A threshold marker 720 may provide visual indication of the target threshold T, allowing users to see whether they have met the minimum contribution requirement. The display may use color coding such as different colors for insufficient, borderline, and sufficient contribution levels.

A stage-by-stage breakdown 730 may display contribution scores for different stages or sections of the work, showing how contribution evolved over time and identifying which phases of the creative process contributed most significantly.

Trend analysis 740 may provide a graphical representation of how the contribution score has changed over time during the session, showing the trajectory and helping users understand whether their current activities are affecting overall contribution.

When C is below T, the system may provide warning notifications 750 indicating the current contribution level relative to the threshold. The warnings may alert users to potential issues while there is still opportunity to address them through additional creative input.

Constructive suggestions 760 may offer actionable recommendations such as providing more detailed prompts, selecting from more candidate variations, manually editing key sections, or arranging elements in unique ways.

Predictive estimates 770 may calculate how many additional creative actions might be needed to reach the threshold, helping users plan their workflow to achieve desired contribution levels.

This real-time feedback system may provide practical value by enabling creators to proactively monitor contribution during the creative process, educating users about what types of creative actions affect authorship metrics, and aligning creator behavior with technical requirements.

### XIV. Third-Party Verification Service

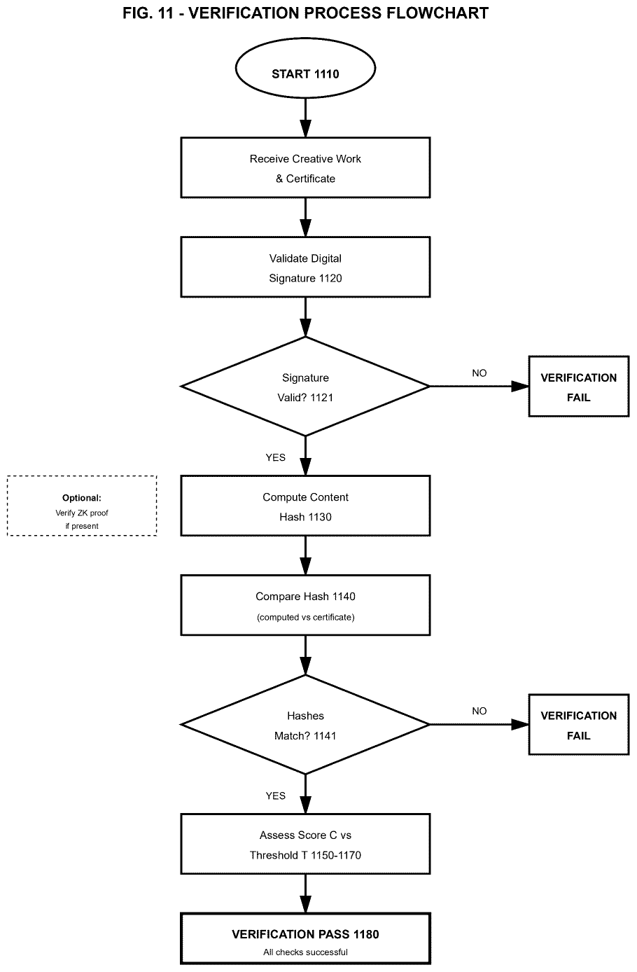

Referring to FIG. 11, in some embodiments, the verification service 140 may enable external parties to validate authorship certificates without requiring trust in the certificate holder. The verification process 1100 may provide cryptographic authentication and attribution assessment with optional zero-knowledge proof verification.

At step 1110, the verification service may receive from a third-party verifier a creative work file and an associated authorship certificate. The verifier may be a content platform, licensing system, regulatory body, or other entity requiring authentication.

At step 1120, the service may validate the digital signature of the authorship certificate using public key infrastructure. This verification may confirm that the certificate was signed by the claimed creator's private key and that the certificate contents have not been altered since signing. If signature validation fails at decision point 1121, the service may return a verification failure.

If the certificate includes a zero-knowledge proof, at step 1125, the service may verify the proof cryptographically to confirm that the attribution score was correctly computed without accessing the private creative inputs. The zero-knowledge proof verification process is described in Section XVIII below. If proof verification fails, the service may return verification failure.

At step 1130, the service may compute a hash of the received creative work using the same algorithm specified in the certificate. At step 1140, the computed hash may be compared against the hash stored in the certificate. If the hashes do not match at decision point 1141, the service may return verification failure indicating the work does not match the certificate.

At step 1150, the service may extract the cumulative human contribution score C from the certificate. At step 1160, the service may extract the threshold T from the certificate or apply a verifier-specified threshold. At step 1170, the service may determine if C≥T to assess contribution sufficiency.

At step 1180, the service may return a verification response. If all checks pass including optional zero-knowledge proof verification and C≥T, the response may indicate successful verification with details including signature validity confirmation, optional proof validity confirmation, hash match confirmation, and contribution score information. If checks pass but C<T, the response may indicate verification with a notation about contribution level. If any cryptographic check fails, the response may indicate failure with specific reasons.

At step 1190, the service may log the verification request for audit trails and statistical analysis. This logging may enable analysis of verification patterns and acceptance rates across different content types and applications.

The verification service may be operated as a public API providing programmatic access, integrated with external systems for automated workflows, or deployed using distributed architectures for scalability and reliability. The inclusion of zero-knowledge proof verification enables the service to provide mathematical certainty of score validity without requiring access to sensitive creative process information.

### XV. Integration Architectures

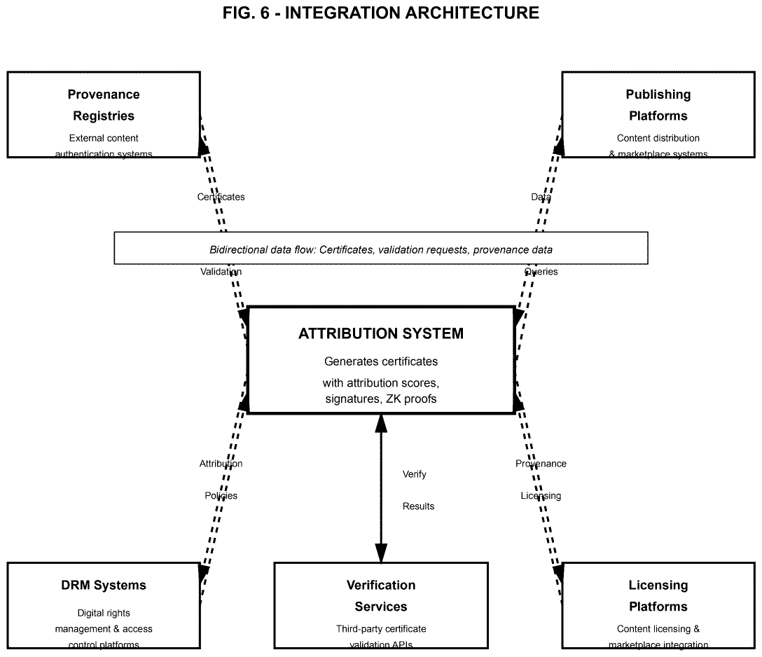

Referring to FIG. 6, the cryptographic attribution system may be designed for flexible integration with diverse downstream systems requiring authenticated provenance data. Integration architectures may enable the attribution certificates to be utilized in various workflows and platforms.

In some embodiments, integration with external content authentication systems may enable connection with provenance registry platforms. The integration may provide certificate submission interfaces, automated validation modules that verify certificates cryptographically including optional zero-knowledge proof verification, and data storage systems for maintaining certificate records.

Content publishing platform integration may enable platforms to verify authorship at content upload time. Publishers may receive content submissions with attached certificates, verify certificate authenticity through cryptographic validation and optional proof verification, extract and assess contribution scores, and apply different treatment based on contribution levels. Zero-knowledge proofs enable publishers to verify scores without requiring creators to disclose sensitive creative process details.

Digital rights management integration may enable DRM systems to incorporate attribution data into usage control policies. Attribution certificates may be associated with content packages, and DRM systems may implement usage restrictions or licensing terms based on verified authorship information.

Licensing platform integration may enable marketplaces to offer authenticated provenance as a feature. Content listings may display verified contribution information with cryptographic proof of validity, and search/filtering systems may incorporate provenance data as selection criteria. The zero-knowledge proof capability enables marketplace participants to trust attribution scores without requiring full disclosure of creative processes.

Regulatory compliance integration may enable automated compliance with content disclosure requirements. Regulatory systems may accept attribution certificates with zero-knowledge proofs as evidence of human contribution levels without requiring disclosure of proprietary creative processes, enabling compliance with AI transparency regulations while protecting trade secrets.

### XVI. Alternative Embodiments and Variations

Those skilled in the art will recognize that numerous variations on the described embodiments are possible while remaining within the scope of the invention. The system architecture is designed for modular deployment, wherein various subsystems and features may be included or omitted based on specific deployment requirements, security constraints, privacy considerations, and integration contexts.

In particular, the following system features are independently optional and may be selectively deployed: (a) blockchain integration as described in Section XII may be omitted entirely, with timestamp verification and public immutability provided through alternative means such as trusted timestamping authorities, centralized audit logs with cryptographic sealing, or enterprise document management systems with versioning controls; (b) zero-knowledge proof generation as described in Section XVIII may be omitted when privacy-preserving verification is not required, such as in internal enterprise deployments where creative process disclosure is acceptable, with verification relying solely on digital signatures and content hashes; (c) trusted execution environment implementation as described in Section XI may be replaced with alternative security architectures including secure multi-party computation, homomorphic encryption, or traditional server-based security with network isolation and access controls; (d) attention-based attribution as described in Section V may be supplemented with, or entirely replaced by, alternative attribution techniques including gradient-based attribution methods, perturbation analysis, model-agnostic explanation techniques, or hybrid approaches combining multiple methodologies; (e) real-time feedback interfaces as described in Section XIII may be omitted in batch processing or post-generation analysis scenarios.

The core inventive concept-quantifying human causal contribution through counterfactual execution analysis comparing factual outputs against baseline counterfactual outputs, computing divergence metrics as attribution scores, and generating cryptographically attested certificates binding those scores to generated content-remains independently patentable and operational with or without these optional enhancements. Each optional feature provides incremental value for specific use cases but is not essential to the fundamental technical contribution of the invention.

Attribution techniques may include additional computational methods such as gradient-based attribution adapted for generation tasks, perturbation-based analysis methods, model-agnostic explanation techniques adapted for generative models, or ensemble methods combining multiple attribution approaches for robust measurement.

Certificate formats may vary including binary encodings for efficiency, JSON or JSON-LD for interoperability, XML formats for compatibility with existing systems, or other structured data formats meeting specific technical requirements. Zero-knowledge proof formats may vary based on the proof system employed, including zk-SNARK proofs, zk-STARK proofs, or other zero-knowledge proof constructions.

Cryptographic methods may use various algorithms including different digital signature schemes such as RSA, ECDSA, or EdDSA, post-quantum signature schemes for future security, different hash functions such as SHA-2, SHA-3, or BLAKE2, various encryption schemes for protecting sensitive certificate fields, and different zero-knowledge proof systems optimized for different security and performance requirements.

Integration architectures may be adapted to specific platform requirements including REST APIs for web services, GraphQL for flexible data queries, gRPC for efficient service-to-service communication, or message queues for asynchronous processing.

User interfaces may range from command-line tools for technical users to graphical applications with visualization features, from browser-based interfaces to native mobile applications, and from simple batch processing tools to interactive real-time feedback systems.

Verification services may operate as centralized systems maintained by trusted entities, decentralized networks using distributed verification protocols leveraging blockchain-based proof verification, or hybrid architectures combining centralized coordination with decentralized execution.

### XVII. Advantages and Technical Benefits

The present invention provides numerous technical advantages over prior art systems. Unlike digital watermarking that merely identifies generating systems, the invention records comprehensive interaction histories throughout generation sessions including creative decisions, iterations, and refinements.

Unlike metadata embedding approaches that lack tamper-evident integrity protection, the invention employs cryptographic attestation with digital signatures preventing post-hoc manipulation, optional hardware security through trusted execution environments, optional blockchain timestamping for public verifiability, and optional zero-knowledge proofs enabling privacy-preserving verification.

Unlike blockchain timestamping that only establishes temporal existence, the invention quantifies causal human contribution through computational analysis using counterfactual execution comparing factual and counterfactual outcomes, attention tracing in neural networks, and aggregation of multiple evidence streams.

Unlike AI explainability research tools, the invention provides production-ready systems for generating practically useful attribution certificates with cryptographic security, standardized formats for interoperability, verification protocols for third-party authentication including privacy-preserving zero-knowledge verification, and integration capabilities for diverse applications.

The counterfactual attribution technique represents a computational approach to measuring human influence on AI-generated outputs. By executing generative models multiple times and measuring divergence, the system may isolate content elements that result from human creative decisions, providing quantitative and reproducible metrics based on causal analysis principles.

The cryptographic certificate structure may bind together multiple evidence streams into tamper-evident records including temporal evidence from timestamp-ordered logs, quantitative evidence from computed attribution scores, reproducibility evidence from model metadata and generation seeds, cryptographic evidence from content hashes and digital signatures, and optional privacy-preserving verification evidence from zero-knowledge proofs. As a result of the disclosed techniques, the system produces machine-verifiable attribution scores that can be embedded into metadata structures, cryptographic attestations, or downstream processing pipelines, thereby altering the operation of the content generation system and associated verification infrastructure. The certificates enable automated decision-making by external systems including content registries, licensing platforms, and regulatory compliance systems that programmatically consume and act upon the attribution data without human intervention.

The zero-knowledge proof capability provides unique advantages enabling privacy-preserving regulatory compliance where creators can demonstrate attribution levels to regulatory bodies without revealing proprietary creative processes, trustless marketplace verification where buyers can verify attribution scores without trusting sellers, confidential competitive advantage where commercial creators can prove authorship without disclosing trade secret methodologies, and mathematical certainty where verification provides cryptographic assurance rather than relying on trust or reputation.

The system architecture may enable flexible deployment through modular design separating decision capture, attribution computation, and cryptographic attestation, integration with existing platforms through standard interfaces, support for multiple generative model architectures, applicability across diverse domains from text to images to multimedia, and optional privacy-preserving features that can be enabled based on application requirements.

By providing cryptographically verifiable, computationally rigorous, privacy-preserving, and practically deployable attribution systems, the present invention may enable secure and authenticated human-AI collaborative content generation, address technical gaps in existing provenance tracking systems, establish infrastructure for content authentication in generative AI applications, and enable regulatory compliance while protecting proprietary creative processes.

Non-Mental Process Requirement. The attribution analysis described herein is not performable by a human mind alone, as it requires repeated execution of a generative model under controlled configurations and computational comparison of high-dimensional output representations. The counterfactual execution technique necessitates programmatic invocation of neural network inference engines with billions of parameters, generation of output tensors with thousands or millions of dimensions, and computation of numerical divergence metrics across these high-dimensional spaces. These operations require computing hardware including processors, memory, and specialized acceleration units, and cannot be reduced to pen-and-paper calculations or mental steps.

Computer Functioning Improvement. The disclosed attribution techniques improve the functioning of generative computing systems by enabling computational differentiation between human-influenced and model-derived output, which is not achievable using conventional AI architectures lacking counterfactual execution control. Rather than merely using a computer as a tool to perform abstract analysis, the invention modifies the operational behavior of AI content generation systems by integrating attribution computation into the generation workflow, producing cryptographically verifiable provenance data as an intrinsic output of the generation process. This technical improvement enables new system capabilities including automated content authentication, programmatic licensing decisions, and regulatory compliance verification that were not possible with prior AI systems.

### XVIII. Zero-Knowledge Attribution Proofs

In some embodiments, the system may generate zero-knowledge proofs to enable privacy-preserving verification of attribution scores. Zero-knowledge proofs allow a prover to demonstrate that a computed attribution score is correct without revealing the underlying creative inputs used in the computation. Referring to FIG. 13, this capability enables trustless verification while maintaining confidentiality of sensitive creative process information.

The zero-knowledge proof generation process may comprise encoding the attribution computation as an arithmetic circuit. The circuit takes as private inputs the recorded human creative inputs and intermediate computation values, and produces as output the cumulative human contribution score C. A zero-knowledge proof π may be generated demonstrating that the prover knows inputs that satisfy the circuit equation:

Attribution_Circuit(inputs)=C

without revealing the specific values of the inputs. In some embodiments, rather than re-executing the entire generative AI model within the zero-knowledge circuit, the circuit may verify correctness of pre-committed intermediate computation values, cryptographic hashes of model outputs, or summarized attribution metrics, thereby maintaining computational feasibility while providing cryptographic assurance of correct attribution computation.

The zero-knowledge proof generation algorithm may be implemented according to the following pseudocode:

Algorithm 4: Zero-Knowledge Proof Generation

Input: creative_inputs I, attribution_score C, circuit_definition Circuit
Output: zero_knowledge_proof π, public_parameters P

| | |
|---|---|
| 1. | // Define witness (all private data) |
| 2. | witness ← {I, intermediate_values, C} |
| 3. | |
| 4. | // Define public inputs (only score and metadata) |
| 5. | public_inputs ← {C, content_hash, timestamp} |
| 6. | |
| 7. | // Verify circuit computes correctly with witness |
| 8. | assert Circuit(witness) = C |
| 9. | |
| 10. | // Generate zero-knowledge proof |
| 11. | π ← ZK_Prove(Circuit, witness, public_inputs) |
| 12. | |
| 13. | // Extract public verification parameters |
| 14. | P ← Extract_Public_Params(Circuit) |
| 15. | |
| 16. | return (π, P) |

In one embodiment, the system may use zk-SNARK (Zero-Knowledge Succinct Non-Interactive Argument of Knowledge) proof systems. The proof generation may comprise defining a computation circuit encoding the attribution algorithm, generating a witness comprising all private values including captured inputs and intermediate computation results, defining public parameters comprising only the final score C, content hash, and timestamp, and computing a proof π using a zk-SNARK proving algorithm such as Groth16 or PLONK.

The zk-SNARK proof provides the following security properties: Zero-knowledge means the verifier learns nothing about the witness (private inputs) beyond the validity of the public statement, succinctness means the proof is small (typically a few hundred bytes) regardless of computation complexity, and non-interactivity means the proof requires no interaction between prover and verifier after generation.

Alternatively, the system may use zk-STARK (Zero-Knowledge Scalable Transparent Argument of Knowledge) proof systems which provide similar functionality without requiring a trusted setup phase. The zk-STARK approach may be preferred when transparency is critical, as it relies only on cryptographic hash functions and does not require generation of trusted parameters. However, zk-STARK proofs are typically larger than zk-SNARK proofs.

The system may select between zk-SNARK and zk-STARK based on deployment requirements:

```
Selection_Criteria = {
  Use zk-SNARK if:
    - Proof size must be minimized (blockchain storage costs)
    - Verification time is critical
    - Trusted setup is acceptable
  Use zk-STARK if:
    - Transparency is required (no trusted setup)
    - Quantum resistance is desired
    - Larger proof size is acceptable
}
```

The zero-knowledge proof may be included in the digital certificate alongside the attribution score. When the certificate is recorded on a distributed ledger as described in Section XII, both the score and the proof may be included in the blockchain transaction, enabling any third party to verify that the score was correctly computed without accessing the private creative inputs.

The verification process for zero-knowledge proofs may be implemented according to the following pseudocode:

Algorithm 5: Zero-Knowledge Proof Verification

Input: zero_knowledge_proof π, public_parameters P, claimed_score C
Output: verification_result (VALID or INVALID)

| | |
|---|---|
| 1. | // Retrieve public inputs from certificate/blockchain |
| 2. | public_inputs ← {C, content_hash, timestamp} |
| 3. | |
| 4. | // Execute cryptographic verification algorithm |
| 5. | result ← ZK_Verify(π, public_inputs, P) |
| 6. | |
| 7. | if result = TRUE then |
| 8. | return VALID |
| 9. | else |
| 10. | return INVALID |
| 11. | end if |

The verification may comprise retrieving the proof π and public parameters P from the blockchain or certificate, executing a verification algorithm that checks the cryptographic validity of the proof using only the public parameters and claimed score, and confirming that the proof demonstrates correct computation of the claimed score. Critically, verification requires no access to the private witness values.

The verification algorithm computes a mathematical check that confirms the proof was generated by someone who knows a valid witness satisfying the circuit constraints. The mathematical relationship may be expressed as:

Verify(π,public_inputs,P)→{TRUE,FALSE}

where TRUE indicates the prover knew a valid witness (the private creative inputs) that produces the claimed attribution score when processed through the attribution algorithm.

The zero-knowledge proof approach may provide advantages including privacy preservation where sensitive creative inputs remain confidential, trustless verification where no trusted third party is required to validate scores, mathematical certainty where verification provides cryptographic assurance rather than relying on signatures alone, regulatory compliance enabling demonstration of attribution levels without disclosing proprietary creative processes, and marketplace efficiency enabling buyers to verify attribution claims from sellers without requiring trust relationships.

In some embodiments, the arithmetic circuit encoding the attribution computation may be decomposed into sub-circuits corresponding to different attribution techniques. A counterfactual attribution sub-circuit may encode the divergence computation D between factual output e and counterfactual output e_baseline:

SubCircuit_Counterfactual:(e,e_baseline)→D

An attention attribution sub-circuit may encode the attention weight summation across transformer layers:

SubCircuit_Attention:(A,H_prompt,L)→HumanAttentionScore

The overall circuit may combine these sub-circuits to produce the final aggregated attribution score:

MainCircuit:(inputs,intermediate_values)→C

The decomposition into sub-circuits may enable modular proof generation where different attribution methods can be proven independently and combined, supporting flexible configurations where users select which attribution methods to apply, and optimizing proof generation performance by parallelizing sub-circuit computations.

The zero-knowledge proof system may be integrated with the trusted execution environment implementation described in Section XI. The TEE may execute proof generation within the secure enclave, ensuring that witness values comprising sensitive inputs never leave the protected environment in unencrypted form. The TEE may generate the proof using sealed cryptographic parameters and output only the proof π and public parameters P, maintaining confidentiality of the creative process.

For distributed ledger integration, the blockchain transaction structure may be extended to include zero-knowledge proof data:

```
BlockchainTransaction = {
  certificate_hash: H(cert),
  attribution_score: C,
  zero_knowledge_proof: π,
  verification_parameters: P,
  content_hash: H(content),
  creator_DID: did:example:creator123,
  timestamp: block_timestamp
}
```

The transaction may be structured to enable efficient on-chain verification where the blockchain smart contract can verify the proof without external computation, or off-chain verification where clients retrieve the proof and verify locally without incurring gas costs.

Smart contract verification may be implemented as:

```
function verifyAttributionProof(
  bytes memory proof,
  uint256 score,
  bytes32 contentHash
) public view returns (bool) {
  // Extract public inputs
  uint256[ ] memory publicInputs = new uint256[ ](2);
  publicInputs[0] = score;
  publicInputs[1] = uint256(contentHash);
  // Verify zero-knowledge proof on-chain
  return zkVerifier.verify(proof, publicInputs);
}
```

This enables decentralized applications to verify attribution scores trustlessly and automatically without relying on centralized verification services.

In embodiments supporting batch processing, multiple attribution certificates may be aggregated into a single zero-knowledge proof demonstrating validity of all scores simultaneously. Batch aggregation may use proof composition techniques where individual proofs π₁, π₂, . . . , π_n are combined into an aggregate proof π_agg:

π_agg=Aggregate(π₁,π₂, . . . ,π_n)

such that verifying π_agg confirms all individual proofs are valid. This batch proof aggregation may reduce blockchain storage costs when recording multiple certificates, improve verification efficiency when validating large collections of attributed content, and enable scalable provenance tracking for high-volume content generation platforms.

The practical deployment of zero-knowledge attribution proofs may involve trade-offs between proof size, generation time, and verification time. As non-limiting examples, typical performance characteristics may include:
zk-SNARK (Groth16):
   Proof size: ~200 bytes
   Proving time: 1-10 seconds (depending on circuit complexity)
   Verification time: 5-50 milliseconds
   Setup: Requires trusted ceremony
zk-STARK:
   Proof size: 50-200 kilobytes
   Proving time: 10-60 seconds
   Verification time: 10-100 milliseconds
   Setup: Transparent (no trusted setup)

System designers may select proof systems based on application requirements, considering factors such as whether blockchain storage costs favor smaller proofs (zk-SNARK), whether transparency requirements favor trustless setup (zk-STARK), whether real-time generation is required favoring faster proving, or whether verification performance is critical for high-throughput applications.

The zero-knowledge proof capability transforms the attribution system from a traditional certificate-based architecture into a privacy-preserving verifiable computation system. This enables new application scenarios including confidential competitive advantage where commercial content creators can prove attribution levels to buyers or platforms without revealing proprietary prompting strategies or creative methodologies, regulatory compliance without disclosure where creators can demonstrate compliance with AI transparency regulations to government bodies without exposing trade secrets, trustless marketplace operation where content marketplaces can verify attribution scores from untrusted sellers without requiring reputation systems or escrow arrangements, and privacy-preserving auditing where internal compliance systems can audit attribution practices without exposing sensitive creative processes to compliance personnel.

What is claimed is:

1. A secure attribution system for quantifying human influence in generative artificial intelligence, the system comprising:
(a) a processor;
(b) a memory storing instructions that, when executed by the processor, cause the system to:
(i) capture, via a decision capture interface, a sequence of human creative inputs during an interactive content generation session with a generative AI model, wherein the human creative inputs comprise at least one of: textual prompts, parameter adjustments, selection operations among multiple AI-generated candidates, rejection operations, manual modifications to generated elements, or structural arrangements of generated components;
(ii) record, in a tamper-evident log structure, each captured human creative input with associated metadata comprising timestamps, input type classifications, and session context information;
(iii) compute, via an attribution engine, human influence metrics for output elements of generated content by executing at least one attribution analysis technique selected from: counterfactual execution analysis comparing outputs generated with human inputs against baseline outputs generated without human inputs, or attention-based token attribution tracing attention weight matrices through neural network layers;
(iv) aggregate the computed human influence metrics to generate a cumulative human contribution score;
(v) generate, via a cryptographic attestation module, a digital certificate comprising: the tamper-evident log of recorded inputs, the cumulative human contribution score, generative AI model metadata including reproducibility parameters, a cryptographic hash of the generated content, and a digital signature binding the certificate to a user identity; and
(vi) output the digital certificate for verification by third parties.

2. The system of claim 1, wherein the counterfactual execution analysis comprises:
(a) executing the generative AI model with the recorded human creative inputs to produce a factual output;
(b) executing the generative AI model without the human creative inputs or with the inputs replaced by neutral defaults to produce a counterfactual output;
(c) computing a divergence measure quantifying differences between the factual output and the counterfactual output; and
(d) normalizing the divergence measure to produce a human influence metric bounded in the range zero to one.

3. The system of claim 2, wherein computing the divergence measure comprises applying a content-type-specific distance function selected from: edit distance for text content, pixel-wise distance or structural similarity index for image content, mel-frequency cepstral coefficients distance for audio content, or frame-wise distance for video content.

4. The system of claim 1, wherein the attention-based token attribution comprises:
(a) identifying prompt tokens provided by a user and generated tokens in output content;
(b) retrieving attention weight matrices from transformer layers of the generative AI model;
(c) computing, for each generated token, a cumulative attention score by summing attention weights directed from the generated token to the prompt tokens across all transformer layers; and
(d) normalizing the cumulative attention score by dividing by a product of a number of transformer layers and a number of prompt tokens to produce the human influence metric.

5. The system of claim 1, wherein capturing human creative inputs comprises recording selection operations in which a user selects one candidate from among N AI-generated alternatives, and wherein computing human influence metrics for the selected candidate comprises calculating a selection attribution score as a function of a logarithm of N.

6. The system of claim 1, wherein capturing human creative inputs comprises recording manual modifications to AI-generated content, and wherein computing human influence metrics comprises:
(a) computing a modification magnitude representing a degree of alteration between an original AI-generated element and a manually modified element; and
(b) assigning a human influence metric based on the modification magnitude, wherein the human influence metric equals one when the modification magnitude exceeds a predetermined threshold.

7. The system of claim 1, wherein aggregating the computed human influence metrics comprises computing a weighted mean wherein each output element is assigned an importance weight based on at least one of: element size, element duration, perceptual importance, or content significance.

8. The system of claim 1, wherein the tamper-evident log structure implements cryptographic chaining wherein each recorded input includes a cryptographic hash of a previous recorded input.

9. The system of claim 1, wherein the cryptographic attestation module operates within a trusted execution environment comprising hardware-isolated secure enclave technology, and wherein cryptographic signing keys are sealed within the trusted execution environment and are not exposed to external software.

10. The system of claim 1, wherein the generative AI model metadata comprises a generation randomness seed enabling third parties to reproduce the content generation process and verify that the recorded inputs produce the generated content.

11. The system of claim 1, further comprising a verification service configured to:
(a) receive a creative work file and an associated digital certificate from a third-party verifier;
(b) validate a digital signature of the certificate using public key infrastructure;
(c) compute a hash of the received creative work and compare the computed hash against a hash stored in the certificate; and
(d) extract the cumulative human contribution score from the certificate and compare the score against a threshold to determine contribution sufficiency.

12. The system of claim 1, further comprising a distributed ledger integration module configured to:
(a) compute a cryptographic hash of the generated digital certificate;
(b) optionally generate a zero-knowledge proof demonstrating that the cumulative human contribution score was correctly computed from the recorded human creative inputs without revealing content of said inputs, wherein the zero-knowledge proof enables third-party cryptographic verification of score validity;
(c) submit a transaction to a blockchain recording the certificate hash, the optional zero-knowledge proof if generated, a creator identifier, and a timestamp; and
(d) store the complete digital certificate in private encrypted storage separate from the blockchain, wherein verification of the score may be performed using the blockchain-recorded proof without accessing the private encrypted storage.

13. The system of claim 1, further comprising a real-time feedback interface configured to:
(a) display, during the content generation session, an evolving cumulative contribution score;
(b) provide visual indication of a target threshold; and
(c) generate suggestions for increasing human contribution when the cumulative contribution score is below the target threshold.

14. A computer-implemented method for generating cryptographically verifiable attribution records quantifying human influence in generative artificial intelligence, the method comprising:
(a) capturing a sequence of human creative inputs during an interactive content generation session with a generative AI model;
(b) recording each captured human creative input in a tamper-evident log with associated metadata;
(c) executing the generative AI model with the recorded human creative inputs to generate factual output;
(d) executing the generative AI model without the human creative inputs to generate counterfactual output;
(e) computing divergence metrics between the factual output and the counterfactual output;
(f) normalizing the divergence metrics to produce human influence scores for output elements;
(g) aggregating the human influence scores to generate a cumulative human contribution score;
(h) generating a digital certificate comprising: the tamper-evident log, the cumulative human contribution score, generative AI model metadata, a cryptographic hash of generated content, and a digital signature; and
(i) outputting the digital certificate for third-party verification.

15. The method of claim 14, wherein the generative AI model comprises a transformer-based language model, and wherein the method further comprises computing attention-based attribution by tracing attention weights from generated tokens to prompt tokens through transformer layers.

16. The method of claim 14, further comprising comparing the cumulative human contribution score against a configurable threshold, and generating a notification when the score is below the threshold.

17. The method of claim 14, wherein generating the digital certificate comprises executing certificate generation and digital signing operations within a hardware-isolated trusted execution environment.

18. The method of claim 14, further comprising:
(a) computing a hash of the digital certificate;
(b) optionally generating a zero-knowledge proof demonstrating score validity without revealing the recorded human creative inputs;
(c) recording the hash and optional zero-knowledge proof on a distributed ledger with an immutable timestamp; and
(d) storing the complete digital certificate in encrypted private storage.

19. A non-transitory computer-readable medium storing instructions that, when executed by a processor, cause the processor to perform operations for quantifying human influence in generative artificial intelligence, the operations comprising:
(a) monitoring user interactions with a generative AI model during a content generation session;
(b) recording human creative inputs comprising at least one of: prompts, parameter adjustments, selections among alternatives, or manual modifications;
(c) computing human influence metrics by executing counterfactual analysis comparing outputs with and without the human creative inputs;
(d) aggregating the human influence metrics into a cumulative contribution score;
(e) generating a cryptographically signed certificate binding the contribution score to generated content via a cryptographic hash; and
(f) enabling third-party verification of the certificate through cryptographic signature validation and hash comparison.

20. The computer-readable medium of claim 19, wherein the operations further comprise integrating with external provenance registry systems by transmitting the cryptographically signed certificate to the external systems for authenticated provenance tracking.

21. The system of claim 1, wherein the attribution engine is configured to dynamically select among multiple attribution analysis techniques based on at least one of: generative AI model architecture, content type, availability of model internals, computational resource constraints, or user-specified preferences, and wherein different output elements within the same generated work may be analyzed using different attribution techniques.
